(19) United States
(12) Patent Application Publication
(10) Pub. No.: US 2017/0302852 A1
(43) Pub. Date: Oct. 19, 2017

(54) Three Axis Gimbals Stabilized Action Camera Lens Unit

(71) Applicant: Jason Tze Wah Lam, San Francisco, CA (US)

(72) Inventor: Jason Tze Wah Lam, San Francisco, CA (US)

(21) Appl. No.: 15/359,612

(22) Filed: Nov. 22, 2016

Related U.S. Application Data
(60) Provisional application No. 62/321,753, filed on Apr. 13, 2016.

(51) Int. Cl. H04N 5/232; H04N 5/225; G03B 17/56

(52) U.S. Cl. CPC H04N 5/23287; H04N 5/23258; H04N 5/23203; G03B 17/561; H04N 5/2254; H04N 5/2256

(57) ABSTRACT

Implementation for a 3D stabilizing gimbals for a lens associated image sensor set for an action camera with remote controlled interchangeable lens is described. The stabilization axis supports a minimum of only image receiving components to minimize stabilizer power requirements.

### BACKGROUND

### Field of the Invention

The present invention generally relates to the field of action camera stabilization and more specifically to a stabilized three axis gimbals Action Camera with wireless.

One of the toughest challenging of shooting video is stabilization. Traditionally, videographers have to either put the camera on tripod, or stand stationary, or require heavy counter weight systems such as steady cams to achieve smooth moving videos. Recently a new technology, brushless gimbals stabilizers was initially developed for stabilizing videos on multicopters, but later have been adopted for ground video use. Brushless gimbals have proven to be very effective in eliminating unsteady moving video taking from both air and ground. Brushless gimbals are used, while steady cam are primarily used by trained professional video and film makers.

Although brushless gimbals allow users to capture smooth and professional looking videos, the added size, weight and cost often discourage the average consumer from adopting brushless gimbals.

It is challenging for quadcopter or drone videographers to port all of the heavy and expensive camera and drone equipment. But for the sake of capturing smooth professional quality aerial photography the larger quad copters are equipped with brushless gimbals. But brushless gimbals are too big and heavy to be integrated to smaller less expensive and light drones.

What is needed are three axis gimbals integrated into a camera in such a way to reduce size, weight and cost.

### SUMMARY

The present invention discloses a three gimbals axis action camera stabilization lens and sensor unit having a stabilizer housing on an action camera containing three gimbals on orthogonal axis controlled by separate torque motors on each axis and pivotally coupled to the housing. The innermost gimbal and stable axis is rigidly supported by the three axis gimbals set having only a lens coupled to an image processor with the lens outward facing from the gimbals center and the image sensor rigidly coupled to receive image signal from the lens, sensor and lens acting as a unit supported by the inner most gimbal axis. The housing contains at least one accelerometer sensor coupled to sensor electronics and logic and each torque motor is rigidly mounted on an orthogonal gimbals axis and electrically coupled to power and control logic responsive to accelerometer signal to axis rotation sensed. Commands received from logic stabilizing the image-sensor unit are processed by logic in addition to logic for receiving image signal from the lens, processing image data and sending image processing data for electronic processing, viewing, stability programs, command and control of the lens-sensor unit. The stabilization of lens-sensor unit via the 3 gimbals axes is insulated from uncontrolled rotation of action camera balance camera components and thereby reduces the overall cameral size and power requirements for image stabilization.

Electronics for wireless communication and control from a smartphone app are also coupled to a wireless receiver and receiving logic.

### BRIEF DESCRIPTION OF DRAWINGS

Specific embodiments of the invention will be described in detail with reference to the following figures.

FIG. 1 shows the 3 axis gimbals stabilized action camera with the lens stabilized by a pan, tilt and roll axis gyro gimbals in an embodiment of the invention.

FIG. 2 shows the gimbals stabilized action camera showing the bottom of the camera gimbals stand and mounting points are located on all four side walls of the camera in an embodiment of the invention.

FIG. 3 shows gimbals stabilized action camera with optional housing for high speed and underwater applications in an embodiment of the invention.

FIG. 4 is a schematic illustration of the 3 axis gimbals isolating a lens and image sensor unit in an embodiment of the invention.

FIG. 5 shows the mechanical structures for a 3 axis gimbals stabilizer unit in an embodiment of the invention.

FIG. 6 illustrates an interchangeable optical package for the 3 axis gimbals stabilizer unit in an embodiment of the invention.

FIG. 7 shows the mechanical structures for a 3 axis brushless torque motor gimbals stabilizer unit in an embodiment of the invention.

FIG. 8 displays a high level flow diagram for logic for remote command control of a 3 axis brushless torque motors for changing camera angle in an embodiment of the invention.

### DETAILED DESCRIPTION

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

### OBJECTS AND ADVANTAGES

The present invention discloses an automated control for a

Another object of the invention is to provide more camera or video time for a UAV without expending full weight of stabilizer on a drone flight battery power.

Yet another object of the invention is to provide a way for users to position their action video takes from easily settable yet hard to reach vantage points.

Another object of the invention is to provide a way for users to position their camera takes from maintainable advantageous vantage points without need for elevation props or ladder placement.

Yet another object of the invention is to provide interchangeable lens.

Another objective of the invention is an action camera with a fully integrated stabilized gimbals for lens and sensor in one unit separate from the camera.

Yet another objective is an action camera having a base to allow the gimbals standing freely so that it can be controlled through a smartphone or remote control device.

Yet another objective is to add features for action camera multiple mounting points.

Another object is to have external electronic contacts for powering and communicating electronics.

Another objective of the invention is to provide plug and play external receivers, microphones, beauty ring lights, external batteries and monitors to the action camera.

### Embodiments of the Invention

Specific embodiments of the invention will be described in detail with reference to the following figures.

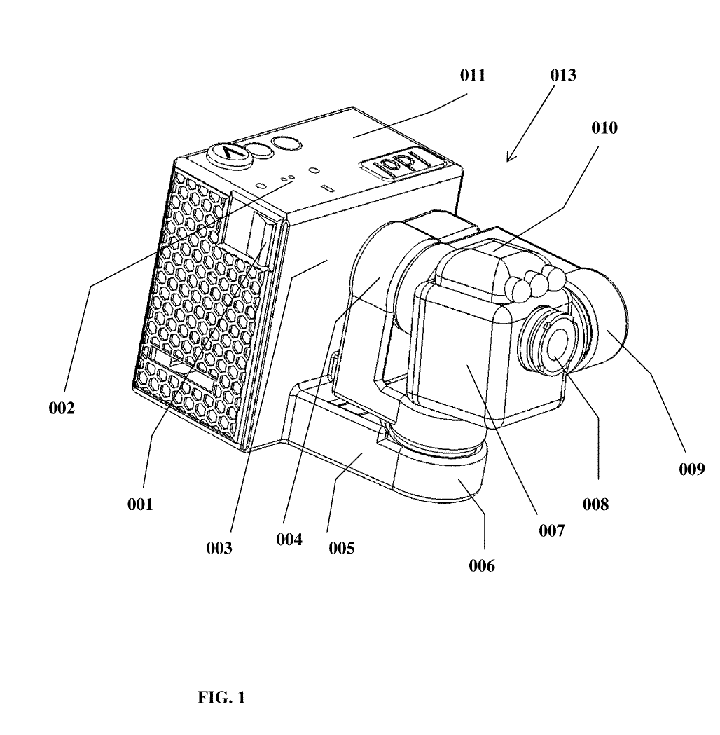

FIG. 1 shows the 3 axis gimbals stabilized action camera with the lens stabilized by a pan, tilt and roll axis gyro gimbals in an embodiment of the invention. FIG. 1 shows the stabilized action camera in the present invention when camera in operation. Stabilized action camera lens housing 007 comprises a lens 008 with camera sensor and an accelerometer and gyro sensor built-into the housing. The camera has a least two communication cables, the first connects the video camera lens 008 supported by housing 007 into the inside of the camera body 003. This cable sends visual imagery data from the lens 008 to the camera processor inside camera body 003, to process video or image and transfer these to a electronic memory housed in the camera body 003. These images are relayed to a monitor screen at rear of the camera to facilitate preview images. The second cable routes acceleration data from accelerometer sensor(s) coupled to the lens 008 inside lens housing 007 which connects the stabilizing gimbals controller inside the camera body 003. With the acceleration data, the stabilizing gimbals controller relays command and control to a tilt axis motor 009, roll axis motor 004 and pan motor 006 operatively coupled to the video camera lens housing 007 to initially isolate the lens 006 and to be responsive to stabilize compensate for any lens 008 movement, while lens is receiving video footage. The lens 008 is removable, clip, slip snap or other mechanism, for lens of different type. A click insertable/removable light 010 has a positive and negative power interface for battery power which insert into the gimbals housing's power interface. In an embodiment of the invention the lighting unit is CG balanced and coupled to the 3-axis gimbals to stabilize the illumination as well.

A variety lighting accessories can be attached to the gimbals housing 007 and include such lighting as ring light for softer beauty lighting affect and different color LED for effects.

The independently supported housing 007 stabilizer lens-image_sensor unit is coupled to an action camera 013, stabilizing unit containing three gimbals on orthogonal axis controlled by torque motors on each axis and pivotally coupled to the action camera.

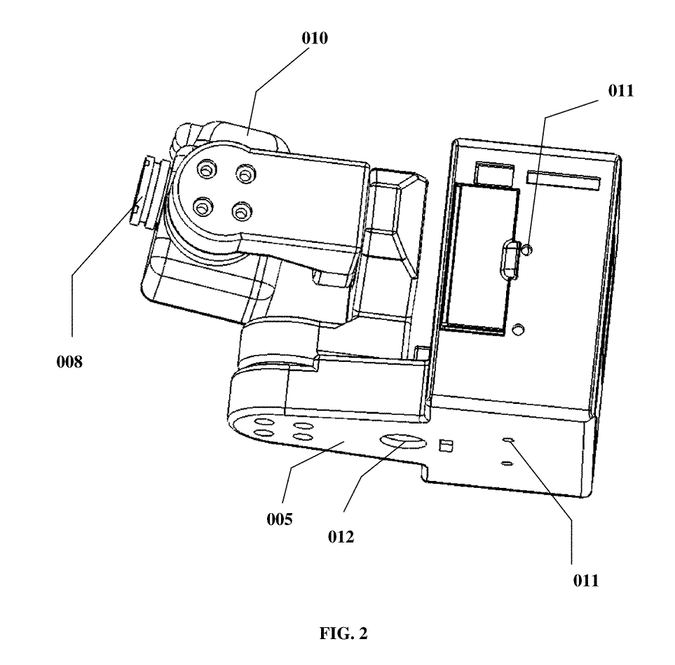

FIG. 2 shows the gimbals stabilized action camera showing the bottom of the camera gimbals stand and mounting points are located on all four side walls of the camera in an embodiment of the invention.

FIG. 2 shows a gimbals stabilized video camera in the preferred embodiment revealing the gimbals stabilized action camera with multiple mounting points. A standard screw socket 012 is typically located on the bottom. But in an embodiment of the invention there are also additional two point mounting holes 011 with built-in electrical contacts on all four side walls. This provides for mounting the camera in circumstance favorable orientations without the need for specialize angled mounting tools. This also provides electrical contacts for connecting additional batteries, lights, monitors, electronics and other accessories. These additional camera accessory connection features solve problems with otherwise difficult to impossible outdoor actions or night/dark situations. A gimbals stand 005 is integrated into the camera which supports the gimbals to stand upright under motion freely without the need of additional static gimbals support from a user. The gimbals stand 005 provides the camera firm support on any surface while stabilizing the image from movement. An app on the smart phone or a controller in wireless communication with camera provide users the capability to frame the photos/video remotely, thus providing higher quality selfie and group photos without the outside manual aid. The user can simply place the gimbals stabilized camera with the mounting holes on any surface and control the precision framing of the camera view even on unstable surfaces.

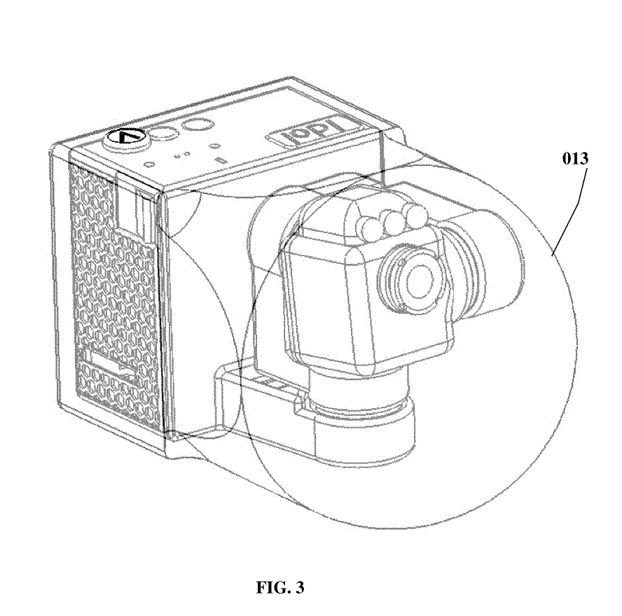

FIG. 3 shows gimbals stabilized action camera with optional housing for high speed and underwater applications in an embodiment of the invention.

FIG. 3 shows the gimbals stabilized video camera on three axis with a clear lens—3D gimbals stabilizer protection housing 013. The lens-gimbals protection housing protects the gimbals stabilized lens camera for applications under water, high speed with high wind resistant where current gimbals stabilizers will fail to function to protect the smaller more fragile gimbals from damage in extreme action conditions.

The gimbals stabilized action/video camera configuration of the present invention is preferably made of plastic, but may also be made of fiberglass, carbon fiber, composite, metal, or any other cameral external environment insulating material providing images to enter the lens.

While the embodiment described above is for an action camera. It should be understood that the invention of an integrated gimbals for stabilizing the lens and sensor(s) instead of the whole camera will greatly reduce the size and form factor, size and/or weight of the entire camera system. This stabilizing lens invention can be coupled to larger or small cameras. The lens and gimbals coupling can also be removeable/insertable in other embodiments. In yet other embodiments the stabilizing gimbals lens can also integrated to each lens as a unit. The lens with stabilized gimbals built-in will allow quick stabilized lens change. While the present invention embodiment illustrates a 3 axis lens stabilizer gimbal, the stabilized gimbals lens can be one or more axis powered by motors, stepper motors, servos, hydraulics, pneumatics, linear motors and any suitable mechanisms providing controlled torque.

In another embodiment, the preferred gimbals stabilized action/video camera can be integrated to a drone, remotely controlled airplanes which transform to and usable as stabilized ground action camera.

In an embodiment, the gimbals of the action camera's tilt, roll, and pan axis and other control functions can be controlled through a transmitter with protocols on devices using blue tooth, wifi, radio and other transmitting devices to the receiver inside the camera body 003 communicating with the isolating gimbals controller.

In another embodiment, the gimbals stabilized action camera lens can be remotely oriented to scan left, right, up and down. And yet in another embodiment, the gimbals stabilized action camera lens using computer embedded vision algorithms or base station communication signal from smart phone to track the user as a cameraman, with camera lens following a selected subject in view.

In another embodiment, the gimbals stabilized action camera lens with its embedded computer vision algorithm having logic to bound or center a self portrait in real time and signal users of an automated cropped portrait or selfie. In another embodiment, the gimbals stabilize not just one lens, but multiple lens attached to the housing for application such as virtual reality capture.

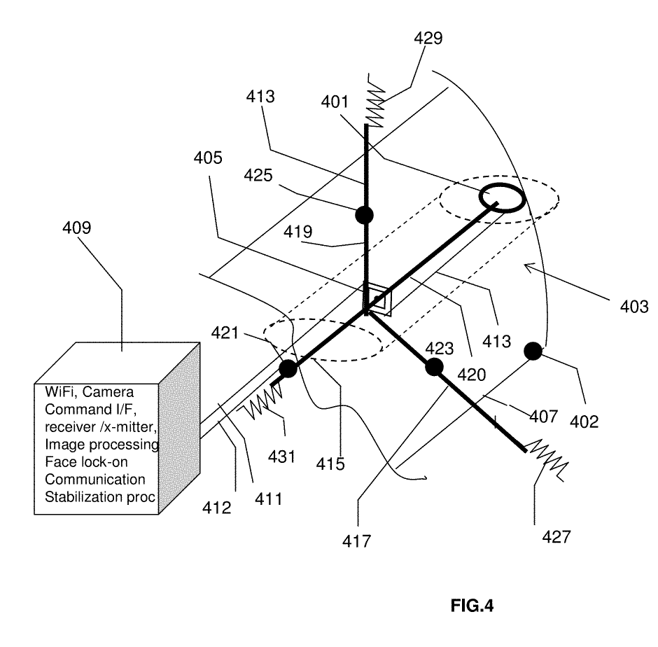

FIG. 4 is a schematic illustration of the 3 axis Gimbals isolating a lens and image sensor unit in an embodiment of the invention. The outer, middle and inner gimbals are controlled through their torque axis 415 417 419 by torque or brushless motors 421 423 425 respectively. The torque or brushless motor control logic 409 is electronically coupled 412 to each motor 421. As with everything except the image sensor and lens subsystems, components are located outside of the 3 axis gimbals assembly. The lens is rigidly coupled to the image sensor 405 and also electronically or photonically in signal communication 413 with images from the lens 401 and optical components sensed by the image sensor 405 and coupled in an insulated lens-image_sensor unit 403. The lens-sensor unit is contained in the camera stablizing housing 407 where 3D accelerometer(s) 402 are likewise contained and coupled to electronics 409 for signal processing and control. The lens-sensor 405 is electronically coupled 411 with the camera processing electronics 409 which contain such components and logic as WiFi, camera command interface for remote control of camera observation angle, image processing, face lock-on, stabilization, signal conditioning, communication for transmission and reception of signal, video processing and more. The coupled electronics facilitate wireless communication and command control from a smartphone app and tracking logic using wifi or bluetooth triangulation.

The innermost gimbal and stablized axis 420 rigidly supporting and having only lens optics 401 rigidly and optically coupled to an image processor 405, the lens 401 outward facing from the gimbals center and the image sensor 405 coupled 413 to receive image signal from the lens optical path 413 with sensor and lens 401 acting as a unit. The housing 407 contained at least one accelerometer sensor 402 which is coupled to sensor electronics and logic 409 for receiving the accelerometer 402 signal for each axis 413 417 420. Each gimbals motor 421 423 425 is rigidly mounted on an orthogonal gimbals axis and electrically coupled to power and control logic 409 which is responsive to each axis accelerometer 402 signal for rotation sensed signals and commands from logic 409 for stabilizing the image-sensor unit 403. The logic 409 for receiving image signal 405 processes the image data and sends image data for viewing, stability processing, command and control of the lens-sensor unit 403. The unit and gimbals will have a 3 axis balance about a zero CG which will depend on the placement of all of the components and their weight and moment contributions about the zero net balanced CG. This may require some adjustment upon component embedment which will be accomplished by adjusting each axis gimbals moment by extension-contraction of an axis 427 429 431 as needed to achieve a zero balance for all 3 axis 417 413 420 respectively about their respective zero balance.

In this embodiment the stabilization of lens-sensor unit via the three gimbals axes is insulated from uncontrolled rotation of action camera balance of all other camera components. This further reduces overall cameral size and power requirements for image stabilization of an action camera.

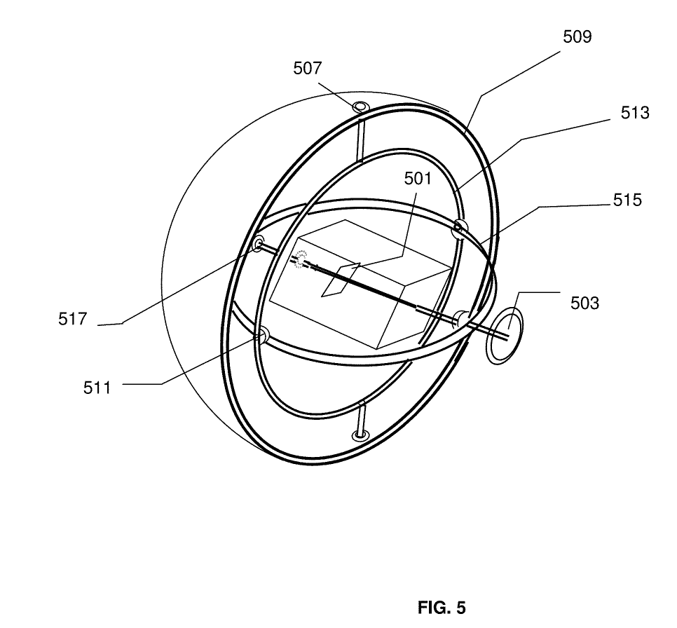

FIG. 5 shows a schematic representation of 3 axis gimbals stabilizer unit in an embodiment of the invention. FIG. 5 shows a 3 axis gimbals stabilizer unit in an embodiment of the invention. The gimbals are roughly a series of concentric rings each on a single axis 513 515 509. The outermost ring rigidly supports the camera lens-sensor 501 503 unit. The next largest ring connects to the outermost ring at two points that are perpendicular to the outer ring's surface mount. The third largest ring mounts to the second largest one at two points perpendicular to the connection between the first and second ring. Each ring can pivot around one axis 509 513 515 with controlling torque motors 507 511 517 respectively and thus insulate the lens-sensor unit from outside rotations by providing a stable axis upon which images are received from the lens and processed on the image sensor insulated from extraneous rotation movement of the camera.

Stated another way, the 3 axis gimbals provide pivoted support to the lens-sensor unit 501 503 responsive to accelerometers that provide acceleration data to the stabilizer electronics and control for responsive lens-sensor unit motion. A set of three axis 509 513 515, one mounted on the other on orthogonal pivot axes rings in gimbals fashion, are used to allow the lens-sensor 501 503 mounted on the innermost ring to remain independent of the rotation of its support structure and housing.

The 3-axis gimbals embodiment provides a stabilization to the lens and image sensor unit, giving camera independence action shooting without camera vibration or shake. Powered by three brushless torque motors 507 511 517, the gimbals have the ability to keep the lens and image level on all axes as the action moves the camera. An inertial measurement unit or accelerometer responds to movement and utilizes its three separate motors 507 511 517 to stabilize the lens-image sensor 501 503 unit. With the guidance of algorithms, the stabilizer is able to notice the difference between deliberate movement such as pans and tracking shots from unwanted shake.

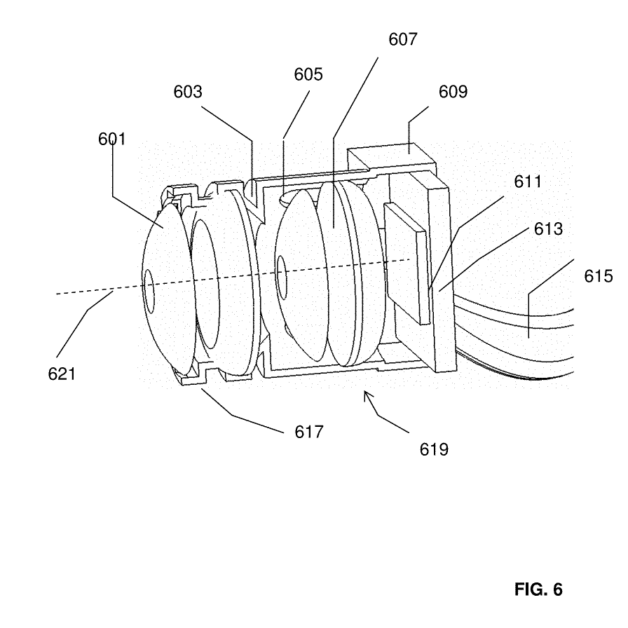

FIG. 6 illustrates an interchangeable optical lens-image_sensor 619 for the 3 axis gimbals stabilizer unit in an embodiment of the invention.

It should be noted that a brushless gimbals works optimally with perfectly balanced components on the stabilized innermost gimbal axis. An imbalance on the stabilized innermost axis will cause the gimbals to use excessive energy to stabilize the off balance weight of any added lenses, lens 601 accessories 607 such as polarizer, compensator, collimator or electronic components 605 611 when the brushless gimbal lacks torque, but is very fast to counter act movements. In that light, the lens assembly 619 shown must be in near perfect in axisymmetic weight balance along the stabilizing axis or optical path 621. For this reason the optical path 621 is aligned with the stabilized axis 621 and the image sensor 611 and other electrical components 605 613 615 will be designed to be weight balanced concentrically around the stabilizing axis centerline.

In another embodiment of the invention the lens-sensor unit is a digital camera that accepts different lens optics, a mirrorless interchangeable-lens camera, AKA a “hybrid camera” or “compact system camera”, but axi-symetrically CG constrained about the optical path axis in alignment with the stabilized 3-axis gimbals axis. The optical lens components can be regular, wide-angle, fish-eye, “pancake”, or telephoto lens with accompanying sensor interchangable units.

Moreover lens interchangeability mounting requires a lens adapter 617 holder and additional optical elements 607 to correct for varied registration distance. Adapters bridge the lens mount with the camera mount, but in an aspect of the invention the lens mount is independent of the camera mount as the stabilized axis in decoupled from the camera by the 3 axis gimbals stabilizing system.

The lens and image sensor will be integrated into an axisymmetric unit 619 which may include optical path necessary components and sensors. Stabilization of the lens optics and image sensor axis 621 require that this combination of component weight distribution is axisymmetrically uniform to the innermost gymbal axis and lens-sensor integrated unit axis to the degree possible. In this embodiment light lenses interchanging into a mounting systems requires an adapter, which in some cases the adapter will require an additional optical element to correct for varied registration distances. Thus the adaptors must be axisymmetrically balanced as well.

In another embodiment the interchangeable lens will be screwed or fastened into the lens adopter adjustable at a depth to achieve sharp image focus on the sensor when inserted inside the lens unit housing. Upon fine balancing the already design balanced lens unit, counter weights can be used to equilibrate CG load in all 3 axis installed in the housing. The counter weight are designed with the proper weight and can be attached to the back or front of the lens housing at designate position to achieve the best balance.

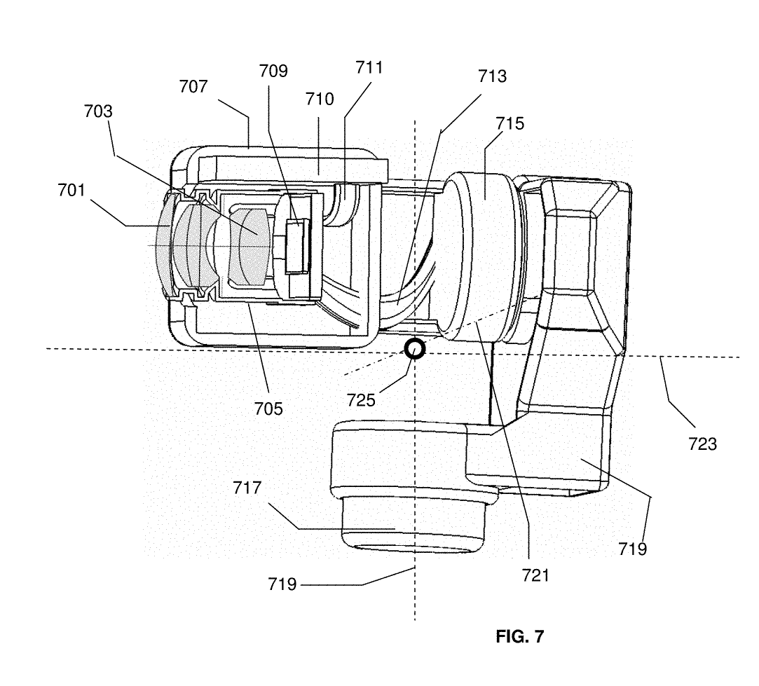

FIG. 7 shows the mechanical structures and components for a 3 axis brushless torque motor gimbals stabilizer unit in an embodiment of the invention. Optical lens assembly 701 703 has an optical lens path aligned for focused images to the unit 705 image sensor 709, all contained by the lens-sensor unit housing 707. The electronic components 710 necessary include an accelerometer, gyro, GPS, sensors, component bus 713 717 brushless torque motors 715 armature 719. The three gimbals axis action camera stabilization lens and sensor unit as shown here provide a leg design which allows attachment and placement on various surfaces for wireless automated operation.

The image sensor 709 can be a CCD, CMOS, sCMOS, NMOS, Live MOS, hyperspectral and multispecteral imager type. The image sensor 709 must optically align with the lens 701 703 components which must all have a combined center of gravity falling along the stabilized inner gimbals axis.

The pitch 719, yaw 719, roll 723 axis for the 3 axis gimbals and payload are shown in dotted lines. The components in the opti-sensor unit 701 703 709 711 713 715 705 707 are placed such that their positions provide a combined CG 725 as near aligned as possible at even balance for each axis 719 721 723. Each axis 719 721 723 is balance tested by placing the axis parallel to the horizon and finding the point on the axis where a line normal to the surface and extending through the axis zero, ie the point on the axis tested where there is no tendency to for the axis to pitch and remains horizontally stable. In an embodiment of the invention the installed unit is then balanced for each axis tested by lengthening or shortening the axis arm until the unit with the gimbals does not pitch positive or negative. Each axis is independently tested by rotating its original disposition 90 degrees to maintain a horizontal parallel and balance adjusted likewise for each independent axis until all the balance zeros on all of the axis are determined. The combined axis 719 721 723 zeros will constitute the CG 725 of the unit and gimbals.

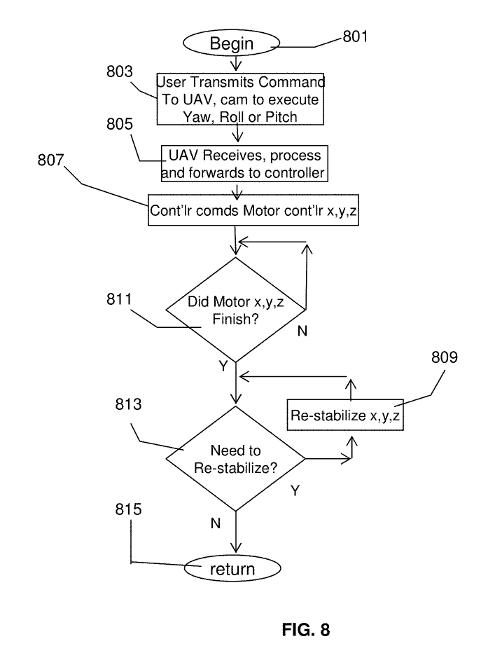

FIG. 8 displays a high level flow diagram for logic for remote command and control of a 3 axis brushless torque motors for changing camera angle in an embodiment of the invention. Logic begins 801 to execute upon a user's transmission to the UAV to move the onboard camera unit to execute a Yaw, Roll or Pitch motion 803. This is to occur in realtime as the user is likely using the onboard camera in First Person View (FPV) mode. WiFi, radio, cellular and any other wireless communication can be used. The UAV has onboard logic to receive commands 805 on a pre-selected frequency, format and protocol in communication with the ground transmitter command unit. Upon reception and authorization the receiver logic 409 forwards the move commands to the main controller which upon formatting forwards the appropriate motor controller, yaw, roll, pitch, the command 807 to turn the motor. The motor controller is responsive to the motor 811 and upon command completion executes a responsive query for any further stabilization 813. If re-stabilization is required logic to re-stabilizes 809 the camera unit is executed and upon completion a return 815 to the controller program is executed. In this fashion the UAV has the logic for receiving remote commands for camera re-positioning and commandeering of the gimbals motors to respond to the user transmitted command requests

While the invention has been described with respect to a limited number of embodiments, those skilled in the art, having benefit of this invention, will appreciate that other embodiments can be devised which do not depart from the scope of the invention as disclosed herein. Other aspects of the invention will be apparent from the following description and the appended claims.

What is claimed is:

1. A three axis gimbals action camera stabilization lens and sensor unit comprising:
a stabilizer lens-image sensor unit housing coupled to an action camera, housing comprising three gimbals on orthogonal axis controlled by torque motors on each axis and pivotally coupled to the action camera;
the innermost gimbals and stabilized axis rigidly supporting and having lens-sensor unit components comprising lens optics rigidly and optically coupled to an image processor, the lens outward facing from the gimbals center and the image sensor coupled to receive image signal from the lens optical path with sensor and lens acting as a unit with more or less uniform weight distribution axi-symetric to the stabilized axis;
the components in the opti-sensor unit having positions such that their weights and moments provide a combined CG as near aligned as possible at even balance for each axis;
the lens-image sensor unit housing containing at least one accelerometer sensor coupled to sensor electronics and logic for receiving the accelerometer signal for each axis;
each gimbal having a motor rigidly mounted on an orthogonal gimbals axis and electrically coupled to power and control logic responsive to each axis accelerometer signal for rotation sensed signals and commands from logic for stabilizing the image-sensor unit;
logic for receiving image signal from the lens, processing image data and sending image data for viewing, stability processing, command and control of the lens-sensor unit;
whereby the stabilization of lens-sensor unit via the 3 gimbals axes is insulated from
uncontrolled rotation of action camera balance camera components and thereby reducing overall cameral size and power requirements for image stabilization.

2. The three gimbals axis action camera stabilization lens and sensor unit as in claim with further comprising coupled electronics and logic for wireless communication and command control from a smartphone app.

3. The three gimbals axis action camera stabilization lens and sensor unit as in claim with further comprising a leg design which allows attachment and placement on various surfaces for wireless automated operation.

4. The three gimbals axis action camera stabilization lens and sensor unit as in claim with further comprising coupled tracking logic using wifi or bluetooth triangulation.

5. The three gimbals axis action camera stabilization lens and sensor unit as in claim 1 further comprising snap/click/slide attachable/removable cartridge lighting physically supported by the housing.

6. The three gimbals axis action camera stabilization lens and sensor unit as in claim with further comprising see through stabilizer housing protective covering.

7. The three gimbals axis action camera stabilization lens and sensor unit as in claim with further comprising interchangeable lens from the set of lenses consisting essentially of regular, wide-angle, telephoto, fish-eye, and aphasic.

8. A method of three axis gimbals action camera stabilization lens further comprising the steps of:
stabilizing a lens-image sensor unit housing coupled to an action camera;
providing a lens-image sensor unit housing comprising three gimbals on orthogonal axis controlled by torque motors on each axis and pivotally coupled to the action camera;
having the innermost gimbal with stablized axis rigidly supporting and having components comprising lens optics rigidly and optically coupled to an image processor;
positioning components in the opti-sensor unit such that their weights and moments provide a combined CG as near aligned as possible at even balance for each axis;
providing the lens outward facing from the gimbals center and the image sensor coupled to receive image signal from the lens optical path with sensor and lens acting as a unit;
having the lens-image sensor unit housing containing at least one accelerometer sensor coupled to sensor electronics and logic for receiving the accelerometer signal for each axis;
controlling each gimbal with a motor rigidly mounted on an orthogonal gimbals axis with electrically coupled to power and controlling logic responsive to each axis accelerometer signal for rotation sensed signals and commands from logic for stabilizing the image-sensor unit;
providing logic for receiving image data from the lens, and
processing image data and sending image data for viewing, stability processing, command and control of the lens-sensor unit.

9. The method of three axis gimbals action camera stabilization as in claim 8 further comprising the steps of coupling electronics and logic for wireless communication and command control from a smartphone app.

10. The method of three axis gimbals action camera stabilization as in claim 8 further comprising the steps of designing a flat leg contact surface which allows attachment and placement on various surfaces for wireless automated operation.

11. The method of three axis gimbals action camera stabilization as in claim 8 further comprising the steps of coupling receiver and transmitter electronics and tracking logic implementing wifi or bluetooth triangulation.

12. The method of three axis gimbals action camera stabilization as in claim 8 further comprising the steps of designing snap/click/slide attachable/removable cartridge lighting module physically supported by the housing.

13. The method of three axis gimbals action camera stabilization as in claim 8 further comprising the steps of providing a see-through stabilizer housing protective covering.

14. The method of three axis gimbals action camera stabilization as in claim 8 further comprising the steps of designing a attachable-removable interchangeable lens in the lens-image unit from the set of lenses consisting essentially of regular, wideangle, telephoto, fish-eye, and aphasic..

15. The method of three axis gimbals action camera stabilization as in claim 8 further comprising the steps of receiving remote commands for camera re-positioning and commandeering the gimbals motors to respond to the command requests.
